(19) United States
(12) Patent Application Publication
(10) Pub. No.: US 2017/0059032 A1
(43) Pub. Date: Mar. 2, 2017

(54) HYDRAULIC PRESSURE SUPPLY SYSTEM OF AUTOMATIC TRANSMISSION

(71) Applicant: Hyundai Motor Company, Seoul (KR)

(72) Inventors: Woochurl Son, Seongnam (KR); Seongwook Ji, Ansan (KR); Ki Dong Kim, Anyang (KR); Yong Uk Shin, Suwon (KR); Wonmin Cho, Hwaseong (KR)

(21) Appl. No.: 15/185,375

(22) Filed: Jun. 17, 2016

(30) Foreign Application Priority Data
Aug. 25, 2015 (KR) 10-2015-0119561

(51) Int. Cl. F16H 57/04; F04C 14/24; F04C 2/344; F04C 15/00; F16H 61/00; F15B 1/02

(52) U.S. Cl. CPC F16H 57/0446; F16H 57/0436; F16H 61/0025; F15B 1/02; F04C 2/344; F04C 15/0057; F04C 14/24; F16H 2061/0034; F16H 2061/0037

(57) ABSTRACT

A hydraulic pressure supply system of an automatic transmission for a vehicle is provided. The system divides a hydraulic pressure generated from first and second pump chambers of a hydraulic pump into a high-pressure and low-pressure part. The system includes first and second input lines that guide oil of an oil pan to the first and second pump chambers. First and second discharge lines discharge the hydraulic pressure generated from the first and second pump chambers. A high-pressure switch valve selectively supplies or recycles the hydraulic pressure supplied from the first discharge line to the high-pressure hydraulic path into the high-pressure part. A pressure accumulator is disposed on a high-pressure hydraulic path between the high-pressure switch valve and the high-pressure part and a low-pressure switch valve selectively supplies or recycles the hydraulic pressure supplied from the second discharge line to the low pressure hydraulic path into the low-pressure part.

### CROSS-REFERENCE TO RELATED APPLICATION

This application claims priority to and the benefit of Korean Patent Application No. 10-2015-0119561 filed in the Korean Intellectual Property Office on Aug. 25, 2015, the entire contents of which are incorporated herein by reference.

### BACKGROUND

(a) Field of the Invention

The present invention relates to a hydraulic pressure supply system of an automatic transmission for a vehicle, and more particularly, to a hydraulic pressure supply system of an automatic transmission for a vehicle that supplies an oil when a hydraulic pressure is only required to minimize a driving loss of a hydraulic pump, thereby maximizing an improvement effect of a fuel consumption.

(b) Description of the Related Art

A hydraulic pump applied to a hydraulic control system of an automatic transmission for a vehicle includes a gear pump, however a vane pump that supplies a sufficient flow has been applied recently for a low rotation speed range. Since the vane pump increases a discharge amount in proportional to the rotation speed, the sufficient flow may be obtained in the low rotation speed range, a driving loss of the pump may be generated while the excessive flow is supplied in a high rotation speed range.

Accordingly, the vane pump forms first and second pump chambers at an axis symmetry position of a rotor to recycle the surplus flow in the high rotation speed range, thereby being used as a main pump chamber and a sub pump chamber. The first pump chamber is used as the main pump chamber and the hydraulic pressure generated from the first pump chamber is supplied to a high-pressure part (a friction member) while being continuously discharged. The second pump chamber is used as the sub pump chamber and the hydraulic pressure generated from the second pump chamber is supplied to the low-pressure part (e.g., a torque converter, a cooling, a lubrication, etc.) or recycled when necessary.

The above information disclosed in this section is merely for enhancement of understanding of the background of the invention and therefore it may contain information that does not form the prior art that is already known in this country to a person of ordinary skill in the art.

### SUMMARY

An exemplary embodiment of the present invention provides a hydraulic pressure supply system of an automatic transmission for a vehicle that supplies oil when a hydraulic pressure is only required to minimize a driving loss of a hydraulic pump, thereby maximizing an improvement effect of fuel consumption.

A hydraulic pressure supply system of an automatic transmission for a vehicle dividing a hydraulic pressure generated from first and second pump chambers of a hydraulic pump made of a vane pump into a high-pressure part and a low-pressure part to be supplied according to an exemplary embodiment of the present invention, may include first and second input lines respectively guiding oil of an oil pan to the first and second pump chambers; first and second discharge lines respectively discharging the hydraulic pressure generated from the first and second pump chambers; a high-pressure switch valve configured to selectively supply or recycle the hydraulic pressure supplied from the first discharge line to the high-pressure hydraulic path into the high-pressure part; a pressure accumulator disposed on a high-pressure hydraulic path between the high-pressure switch valve and the high-pressure part; and a low-pressure switch valve configured to selectively supply or recycle the hydraulic pressure supplied from the second discharge line to the low pressure hydraulic path into the low-pressure part.

The high-pressure switch valve and the low-pressure switch valve may be independently operated and adjusted by the first and second solenoid valves. The first and second solenoid valves respectively operating the high-pressure switch valve and the low-pressure switch valve may be an on/off solenoid valve. Additionally, the high-pressure switch valve may be configured to convert a hydraulic path to supply the hydraulic pressure transmitted from the first discharge line during the off control of the first solenoid valve to the high-pressure part and to recycle the hydraulic pressure to the side of the first and second input lines through the first recycle hydraulic path during the on control of the first solenoid valve.

The low-pressure switch valve may be configured to convert a hydraulic path to supply the hydraulic pressure transmitted from the second discharge line during the off control of the second solenoid valve to the low-pressure part and to recycle the hydraulic pressure during the on control of the second solenoid valve to the side of the first and second input lines through the second recycle hydraulic path. The first solenoid valve may be on-controlled to recycle the hydraulic pressure when the hydraulic pressure is increased to be greater than a predetermined pressure of the pressure accumulator.

An exemplary embodiment of the present invention provides the hydraulic pump as a mechanical vane pump and the hydraulic pressure may be recycled when the hydraulic pressure supplied from the hydraulic pump 10 to the high-pressure part HP is increased to be greater than the predetermined value of the pressure accumulator. Accordingly, by applying the mechanical vane pump of low cost instead of the hydraulic pump, a production cost may be reduced. When the hydraulic pressure supplied to the high-pressure part is increased to be greater than the predetermined value of the pressure accumulator, the hydraulic pressure supplied to the high-pressure part may be prevented to be recycled an thus, the driving load of the hydraulic pump may be reduced, thereby improving the fuel consumption.

Further, effects that can be obtained or expected from exemplary embodiments of the present invention are directly or suggestively described in the following detailed description. That is, various effects expected from exemplary embodiments of the present invention will be described in the following detailed description.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIG. 1 is a schematic diagram of a hydraulic pressure supply system according to an exemplary embodiment of the present invention;

FIG. 2 as a configuration diagram of a hydraulic pressure supply system according to an exemplary embodiment of the present invention is a fluid flowchart when a hydraulic pressure is supplied to a high-pressure part and a low-pressure part;

FIG. 3 as a configuration diagram of a hydraulic pressure supply system according to an exemplary embodiment of the present invention is a fluid flowchart when a hydraulic pressure is only supplied to a high-pressure part;

FIG. 4 as a configuration diagram of a hydraulic pressure supply system according to an exemplary embodiment of the present invention is a fluid flowchart when a hydraulic pressure is only supplied to a low-pressure part; and

FIG. 5 as a configuration diagram of a hydraulic pressure supply system according to an exemplary embodiment of the present invention is a fluid flowchart when a hydraulic pressure is not simultaneously supplied to a high-pressure part and a low-pressure part.

### DESCRIPTION OF SYMBOLS

10: vane pump
100: rotor
101, 102: first, second pump chambers
101a, 102a: first, second input ports
101b, 102b: first, second discharge ports
101c, 102c: first, second input lines
101d, 102d: first, second discharge lines
12: high-pressure switch valve
14: low-pressure switch valve
16: high-pressure hydraulic path
18, 22: first, second recycle hydraulic paths
20: low pressure hydraulic path
HP: high-pressure part
LP: low-pressure part
SOL1, SOL2: first, second solenoid valves

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, ^{an} _{and} ^{the} are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Parts not relevant to description of exemplary embodiments of the present invention are omitted for describing the present invention clearly, and throughout the specification, identical or similar elements are given the same reference numerals. Though terms including ordinal numbers, such as first or second, can be used for describing various elements, the elements are not confined by the terms, and are used only for making one element distinctive from other elements.

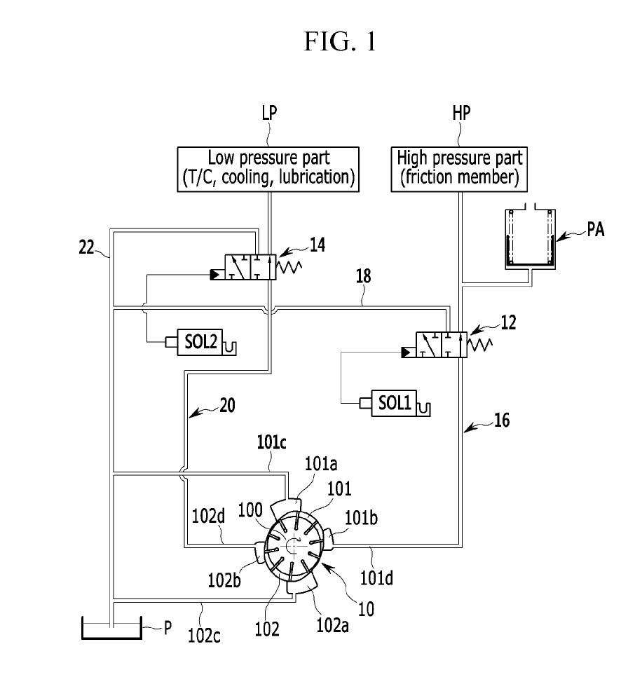

FIG. 1 is a schematic diagram of a hydraulic pressure supply system according to an exemplary embodiment of the present invention. Referring to FIG. 1, the hydraulic pressure supply system according to an exemplary embodiment of the present invention may be divided into a low-pressure part LP and a high-pressure part HP and a hydraulic pressure generated from a hydraulic pump 10 may be divided and supplied to the low-pressure part LP and the high-pressure part HP.

Particularly, the low-pressure part LP indicates a part in which a low pressure (e.g., 4 bar) of a level for an operation of a torque converter (T/C), a cooling, and a lubrication is adjusted and supplied, and the high-pressure part HP indicates a part in which a high pressure (e.g., 18 bar) capable of smoothly operating a plurality of friction members that are selectively operated during shift is adjusted and supplied.

As described above, the hydraulic pressure supply system according to an exemplary embodiment of the present invention may be divided in the low-pressure part LP and the high-pressure part HP and may include a hydraulic pump 10, a high-pressure switch valve 12, a low-pressure switch valve 14, a pressure accumulator (pressure accumulator; PA), and a first and second solenoid valves SOL1 and SOL2. The hydraulic pump 10 may be a vane pump, and the vane pump may include a first pump chamber 101 and a second pump chamber 102 at an axis symmetry position of the rotor 100.

The first pump chamber 101 and the second pump chamber 102 may respectively include first and second input ports 101a and 102a and first and second discharge ports 101b and 102b. The first and second input ports 101a and 102a may be respectively connected to the oil pan P via the first and second input lines 101c and 102c, and the first and second discharge ports 101b and 102b may be respectively connected to the first and second discharge lines 101d and 102d. The first discharge line 101d may be connected to the high-pressure hydraulic path 16 that supplies the hydraulic pressure to the high-pressure part HP, the high-pressure switch valve 12 and the pressure accumulator PA may be disposed on the high-pressure hydraulic path 16.

Additionally, the high-pressure switch valve 12 may be configured to supply or recycle the hydraulic pressure to the high-pressure part HP while being operated or adjusted by the first solenoid valve SOL1, and the recycled hydraulic pressure may be recycled to the first and second input lines 101c and 102c through the first recycle hydraulic path 18. The first solenoid valve SOL1 may be an ON/OFF solenoid valve. In particular, when the hydraulic pressure is to be supplied to the high-pressure part HP, the OFF control may be executed and when the hydraulic pressure supplied to the high-pressure part HP is prevented to be recycled, the ON control may be executed. The respective solenoid valves may be operated by a controller (not shown).

When the hydraulic pressure supplied to the high-pressure part HP is increased to be greater than a predetermined pressure of the pressure accumulator PA, the first solenoid valve SOL1 may be ON-controlled and may be configured to recycle the hydraulic pressure while converting the hydraulic path of the high-pressure switch valve 12. The pressure accumulator PA may be disposed under the high-pressure switch valve 12 to absorb the pulsation or the impact of the hydraulic pressure supplied to the high-pressure part HP and may be configured to execute a function of maintaining the hydraulic pressure during a predetermined period of time after preventing the hydraulic pressure supply of the high-pressure part HP.

The second discharge line 102d may be connected to the low pressure hydraulic path 20 that supplies the hydraulic pressure to the low-pressure part LP, and the low-pressure switch valve 14 may be disposed on the low pressure hydraulic path 20. The low-pressure switch valve 14 may be configured to supply and recycle the hydraulic pressure to the low-pressure part LP while being operated and adjusted by the second solenoid valve SOL2, and the hydraulic pressure recycled from the low-pressure switch valve 14 may be recycled to the first and second input lines 101c and 102c via the second recycle hydraulic path 22. The second solenoid valve SOL2 may be the ON/OFF solenoid valve operated by a controller. In particular, when the hydraulic pressure is to be supplied to the low-pressure part LP, the OFF control may be executed and when the hydraulic pressure supplied to the low-pressure part LP is prevented to be recycled, the ON control may be executed.

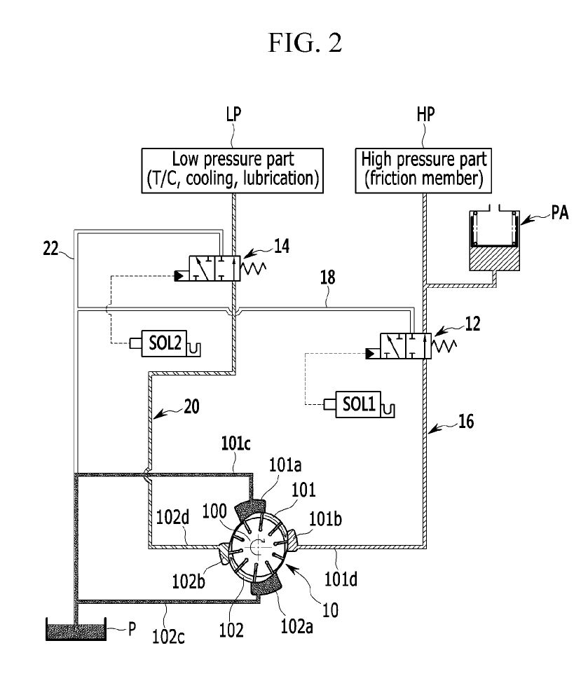

FIG. 2 as a configuration diagram of a hydraulic pressure supply system according to an exemplary embodiment of the present invention is a fluid flowchart when a hydraulic pressure is supplied to a high-pressure part and a low-pressure part. Referring to FIG. 2, when the hydraulic pressure is controlled to be supplied to both sides of the high-pressure part HP and the low-pressure part LP, the first and second solenoid valves SOL1 and SOL2 may be OFF-controlled.

Thus, the hydraulic pressure of the hydraulic pump 10 may be supplied to the high-pressure part HP through the high-pressure switch valve 12 and may simultaneously be supplied to the low-pressure part LP through the low-pressure switch valve 14. When the hydraulic pressure supplied to the high-pressure part HP is increased to be greater than the predetermined pressure (e.g., 30 bar) of the pressure accumulator PA, while the first solenoid valve SOL1 is ON-controlled, as the hydraulic pressure of the high-pressure hydraulic path 16 is recycled through the first recycle hydraulic path 18, the driving load of the hydraulic pump 10 may be reduced, thereby reducing the power loss.

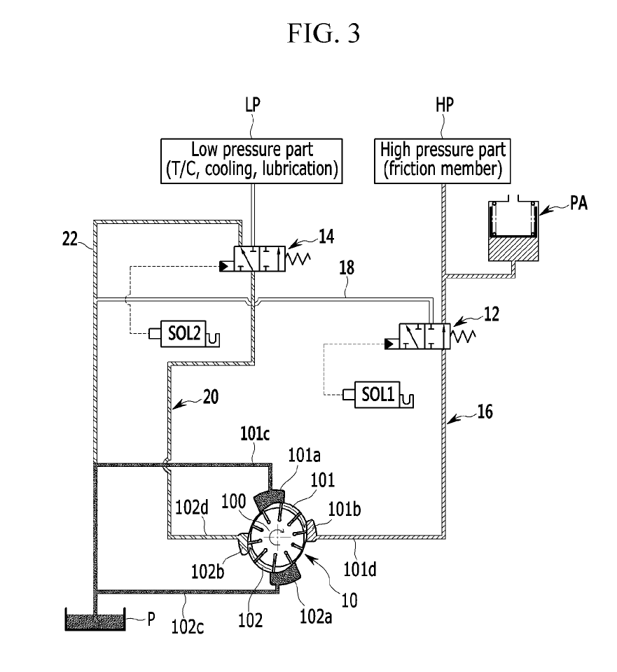

FIG. 3 as a configuration diagram of a hydraulic pressure supply system according to an exemplary embodiment of the present invention is a fluid flowchart when a hydraulic pressure is only supplied to a high-pressure part. Referring to FIG. 3, when the hydraulic pressure is supplied to the high-pressure part HP and the hydraulic pressure is not supplied to the low-pressure part LP, the first solenoid valve SOL1 may be OFF-controlled and the second solenoid valve SOL2 may be ON-controlled.

Thus, the hydraulic pressure of the hydraulic pump 10 may be supplied to the high-pressure part HP and the low-pressure part LP through the high-pressure switch valve 12, in this case, the hydraulic pressure supplied to the high-pressure part HP may be normally supplied by the OFF control of the first solenoid valve SOL1, and the hydraulic pressure supplied to the low-pressure part LP may be recycled through the second recycle hydraulic path 22 by the ON control of the second solenoid valve SOL2. Additionally, when the hydraulic pressure supplied to the high-pressure part HP is increased to be greater than the predetermined pressure of the pressure accumulator PA, while the first solenoid valve SOL1 is ON-controlled, a the hydraulic pressure of the high-pressure hydraulic path 18 may be recycled through the first recycle hydraulic path 18, the driving load of the hydraulic pump 10 may be reduced, thereby reducing the power loss.

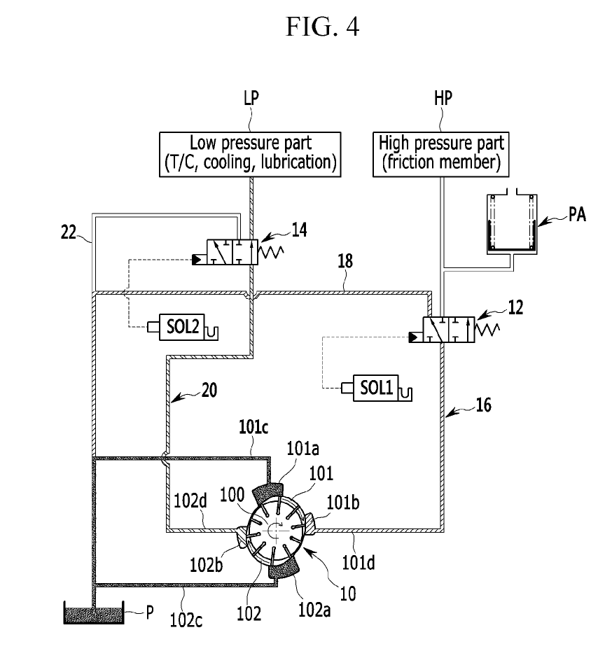

FIG. 4 as a configuration diagram of a hydraulic pressure supply system according to an exemplary embodiment of the present invention is a fluid flowchart when a hydraulic pressure is only supplied to a low-pressure part. Referring to FIG. 4, when the hydraulic pressure is not supplied to high-pressure part HP and the hydraulic pressure is not supplied to the low-pressure part LP, the first solenoid valve SOL1 may be ON-controlled and the second solenoid valve SOL2 may be OFF-controlled.

Thus, the hydraulic pressure of the hydraulic pump 10 may be supplied to the high-pressure part HP and the low-pressure part LP through the high-pressure and low-pressure switch valves 12 and 14, in this case, the hydraulic pressure supplied to the high-pressure part HP may be recycled through the first recycle hydraulic path 18 by the ON control of the first solenoid valve SOL1, and the hydraulic pressure supplied to the low-pressure part LP may be normally supplied by the OFF control of the second solenoid valve SOL2.

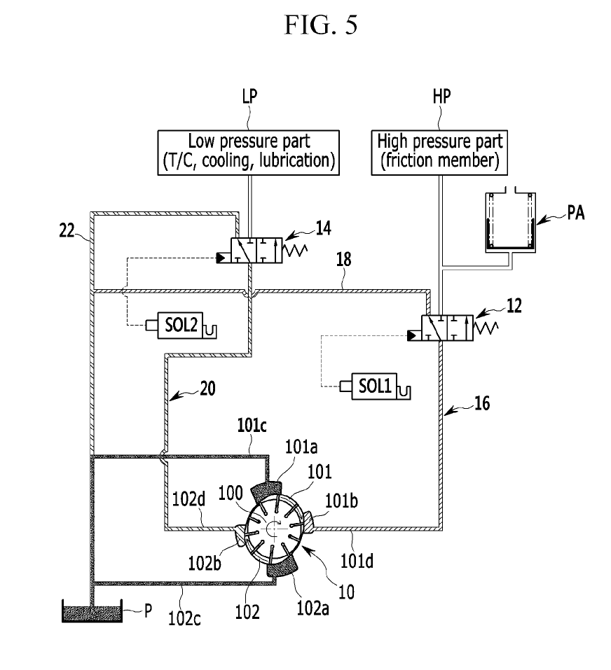

FIG. 5 as a configuration diagram of a hydraulic pressure supply system according to an exemplary embodiment of the present invention is a fluid flowchart when a hydraulic pressure is not simultaneously supplied to a high-pressure part and a low-pressure part. Referring to FIG. 5, when the hydraulic pressure is not completely supplied to the high-pressure part HP and the low-pressure part LP, the first and second solenoid valves SOL1 and SOL2 may be ON-controlled.

Thus, the hydraulic pressure supplied to the high-pressure part HP may be recycled through the first recycle hydraulic path 18 by the ON-control of the first solenoid valve SOL1, and the hydraulic pressure supplied to the low-pressure part LP may be recycled through the second recycle hydraulic path 22 by the ON control of the second solenoid valve SOL2, thereby reducing the driving resistance of the hydraulic pump 10.

As described above, the hydraulic pressure supply system of the automatic transmission for the vehicle according to an exemplary embodiment of the present invention may include the hydraulic pump 10 operating a mechanical vane pump and the hydraulic pressure supply system may be configured to execute a recycle when the hydraulic pressure supplied from the hydraulic pump 10 to the high-pressure part HP is increased to be greater than the predetermined value of the pressure accumulator PA.

Accordingly, by applying the mechanical vane pump of low cost instead of the hydraulic pump, a production cost may be reduced, when the hydraulic pressure supplied to the high-pressure part HP is increased to be greater than the predetermined value of the pressure accumulator PA, the hydraulic pressure supplied to the high-pressure part HP may be prevented to be recycled and thus the driving load of the hydraulic pump 10 may be reduced, thereby improving the fuel consumption.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A hydraulic pressure supply system of an automatic transmission for a vehicle dividing a hydraulic pressure generated from first and second pump chambers of a hydraulic pump formed as a vane pump into a high-pressure part and a low-pressure part to be supplied, comprising:
first and second input lines respectively configured to guide oil of an oil pan to the first and second pump chambers;
first and second discharge lines respectively configured to discharge the hydraulic pressure generated from the first and second pump chambers;
a high-pressure switch valve configured to selectively supply or recycle the hydraulic pressure supplied from the first discharge line to the high-pressure hydraulic path into the high-pressure part;
a pressure accumulator disposed on a high-pressure hydraulic path between the high-pressure switch valve and the high-pressure part; and
a low-pressure switch valve configured to selectively supply or recycle the hydraulic pressure supplied from the second discharge line to the low pressure hydraulic path into the low-pressure part.

2. The hydraulic pressure supply system of claim 1, wherein the high-pressure switch valve and the low-pressure switch valve are independently operated and adjusted by the first and second solenoid valves.

3. The hydraulic pressure supply system of claim 2, wherein: the first and second solenoid valves respectively operating the high-pressure switch valve and the low-pressure switch valve are formed as an on/off solenoid valve.

4. The hydraulic pressure supply system of claim 2, wherein the high-pressure switch valve is configured to convert a hydraulic path to supply the hydraulic pressure transmitted from the first discharge line during the off control of the first solenoid valve to the high-pressure part and to recycle the hydraulic pressure to a side of the first and second input lines through the first recycle hydraulic path during the on control of the first solenoid valve.

5. The hydraulic pressure supply system of claim 2, wherein the low-pressure switch valve is configured to convert a hydraulic path to supply the hydraulic pressure transmitted from the second discharge line during the off control of the second solenoid valve to the low-pressure part and to recycle the hydraulic pressure during the on control of the second solenoid valve to a side of the first and second input lines through the second recycle hydraulic path.

6. The hydraulic pressure supply system of claim 4, wherein the first solenoid valve is on-controlled to recycle the hydraulic pressure when the hydraulic pressure is increased to be greater than a predetermined pressure of the pressure accumulator.

7. A hydraulic pressure supply system of an automatic transmission of a vehicle dividing a hydraulic pressure generated from first and second pump chambers of a hydraulic pump formed as a vane pump into a high-pressure part and a low-pressure part to be supplied, comprising:
first and second input lines respectively configured to guide oil of an oil pan to the first and second pump chambers;
first and second discharge lines respectively configured to discharge the hydraulic pressure generated from the first and second pump chambers;
a high-pressure switch valve configured to selectively supply or recycle the hydraulic pressure supplied from the first discharge line to the high-pressure hydraulic path by the control of the first solenoid valve made of an on/off solenoid valve into the high-pressure part;
a pressure accumulator disposed on a high-pressure hydraulic path between the high-pressure switch valve and the high-pressure part; and
a low-pressure switch valve configured to selectively supply or recycle the hydraulic pressure supplied from the second discharge line to the low pressure hydraulic path by the control of the second solenoid valve made of the on/off solenoid valve to the low-pressure part.

8. The hydraulic pressure supply system of claim 7, wherein:
the high-pressure switch valve is configured to convert a hydraulic path to supply the hydraulic pressure transmitted from the first discharge line during the off control of the first solenoid valve to the high-pressure part and to recycle the hydraulic pressure to a side of the first and second input lines through the first recycle hydraulic path during the on control of the first solenoid valve, and
the low-pressure switch valve is configured to convert a hydraulic path to supply the hydraulic pressure transmitted from the second discharge line during the off control of the second solenoid valve to the low-pressure part and to recycle the hydraulic pressure during the on control of the second solenoid valve to the side of the first and second input lines through the second recycle hydraulic path.

9. The hydraulic pressure supply system of claim 8, wherein the first solenoid valve is on-controlled to recycle the hydraulic pressure when the hydraulic pressure is increased to be greater than a predetermined pressure of the pressure accumulator.

10. The hydraulic pressures supply system of claim 7, wherein the high-pressure part is a friction member and the low-pressure part is a torque converter, a cooling part, or a lubrication part.
